(19) United States
(12) Patent Application Publication
(10) Pub. No.: US 2007/0208728 A1
(43) Pub. Date: Sep. 6, 2007

(54) Predicting demographic attributes based on online behavior

(75) Inventors: Benyu Zhang, Beijing (CN); Honghua Dai, Sammamish, WA (US); Hua-Jun Zeng, Beijing (CN); Li Qi, Beijing (CN); Tarek Najm, Kirkland, WA (US); Teresa B. Mah, Bellevue, WA (US); Vladimir Shipunov, Seattle, WA (US); Ying Li, Bellevue, WA (US); Zheng Chen, Beijing (CN)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 11/366,526

(22) Filed: Mar. 3, 2006

(51) Int. Cl. G06F 17/30

(52) U.S. Cl. 707/5

(57) ABSTRACT

This invention provides a system and method for predicting user demographic attributes for non-registered users and users with incomplete profiles. The invention uses demographic information from registered users and user search history logs to create a database of information that associates the users' search history habits with their demographic attributes. The invention creates a first database that associates users' search query history with their demographic attributes, and also creates a second database that associates web pages that users have visited frequently along with the users' demographic attributes. The invention can compare the searching and browsing habits of non-registered users and users with incomplete profiles to the searching and browsing habits of registered users. Through the comparison, the invention can use the corresponding demographic attributes of the registered users to predict the demographic attributes of the non-registered users and the registered users with incomplete profiles.

### CROSS-REFERENCE TO RELATED APPLICATION

Not applicable.

### STATEMENT REGARDING FEDERALLY SPONSORED RESEARCH OR DEVELOPMENT

Not applicable.

### BACKGROUND

Online advertisers prefer to target ads at a specific audience. The target audience can be selected using demographic information such as age, gender, income, city of residence, etc. However, many online users may not be registered, and therefore have not provided their demographic information voluntarily. Additionally, registered users may give incomplete or even incorrect demographic information.

Incomplete and non-existent user profiles of demographic attributes can limit the usage of demography-based ads targeting. Therefore, it may be desirable to provide an approach in which user demographic attributes can be predicted even if a user is a non-registered user or a registered user with an incomplete profile.

### SUMMARY

A system and method are provided for predicting user demographic attributes for non-registered users and users with incomplete user profiles. A method provided includes receiving a search query, extracting at least one feature associated with the search query, correlating each extracted feature with one or more attributes, and determining a demographic profile based on the correlated attributes. Another method provides identifying a document, extracting at least one feature associated with the identified document, correlating the at least one feature with one or more attributes, and determining a first demographic profile based on the one or more attributes.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 illustrates an embodiment of a system for implementing the invention.

FIGS. 2A and 2B illustrate embodiments of detailed representations of a query demographic predictor and page demographic predictor.

FIG. 3 illustrates an embodiment of a method for creating a query-demographic classifier.

FIG. 4 illustrates an embodiment for predicting the demographic attributes of a user once the query-demographic classifier has been created.

FIG. 5 illustrates an embodiment of a method for creating a page-demographic classifier.

FIG. 6 illustrates an embodiment of a method for predicting the demographic attributes of a user browsing a particular web page once the page-demographic classifier has been created.

FIG. 7 illustrates an embodiment of a method for predicting demographic attributes using a user-demographic predictor.

### DETAILED DESCRIPTION

In various embodiments, the invention provides a system and method for predicting user demographic attributes. The invention uses a search log of user search history and a user profile database of registered user demographic attributes to create a first database. The first database includes features of search results associated with submitted search queries and are associated with corresponding user demographic attributes. The invention also creates a second database that includes features from web pages that have been browsed by the registered users and are associated with corresponding user demographic attributes. The first and second databases are used to create a query-demographic predictor and a page-demographic predictor respectively. By using information such as the searching history and demographic attributes of registered users, the query and page-demographic predictors can help predict the demographic attributes of non-registered users and users with incomplete profiles that have similar searching habits and web browsing habits as the registered users.

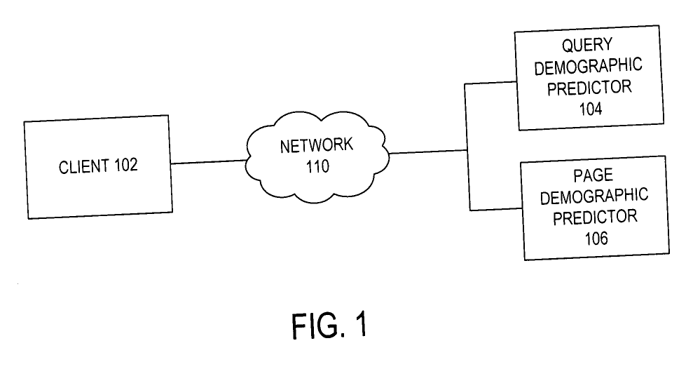

FIG. 1 illustrates an embodiment of a system for implementing the invention. Client 102 can be a desktop or laptop computer, a network-enabled cellular telephone (with or without media capturing/playback capabilities), wireless email client, or other client, machine, device, or combination thereof, to perform various tasks including Web browsing, search, electronic mail (email) and other tasks, applications and functions. Client 102 may additionally be any portable media device such as digital still camera devices, digital video cameras (with or without still image capture functionality), media players such as personal music players and personal video players, and any other portable media device.

Query-demographic predictor 104 and page-demographic predictor 106 may be or can include a server including, for instance, a workstation running the Microsoft Windows®, MacOS™, Unix, Linux, Xenix, IBM AIX™, Hewlett-Packard UX™, Novell Netware™, Sun Microsystems Solaris™, OS/2™, BeOS™, Mach, Apache, OpenStep™ or other operating system or platform. In an embodiment, client 102 may also be a server.

Client 102 can include a communication interface. The communication interface can be an interface that allows the client to be directly connected to any other client or device or that allows the client 102 to be connected to a client, server, or device over network 110. Network 110 can include, for example, a local area network (LAN), a wide area network (WAN), or the Internet. In an embodiment, the client 102 can be connected to another client, server, or device via a wireless interface.

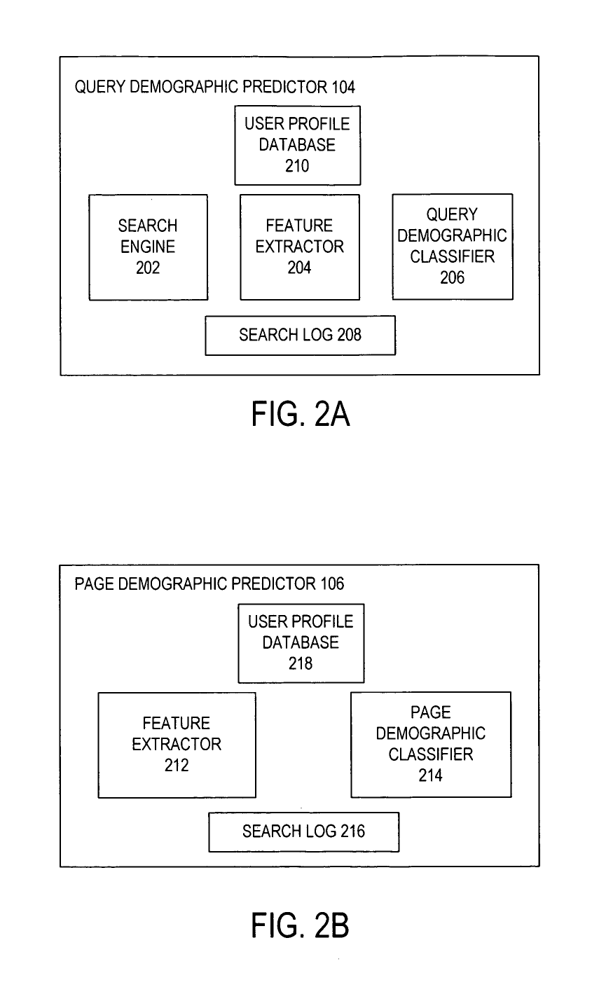

FIG. 2A illustrates an embodiments of a query-demographic predictor 104, and FIG. 2B illustrates an embodiment of a page demographic predictor 106. A query-demographic predictor is used to predict a confidence level for a particular demographic attribute given a certain search query. For example, the query-demographic predictor could predict the likelihood that a particular search query came from a specific gender. In another example, the query-demographic predictor could predict the likelihood that a particular search query came from someone at a specific location. The query-demographic predictor can predict any type of demographic attribute given a search query and should not be limited to just gender and location.

Query demographic predictor 104 can include a search engine 202, a feature extractor 204, a query-demographic classifier 206, a search log 208, and a user profile database 210. Feature extractor 204 can be any conventional feature extractor such as, but not limited to, a Document Frequency (DF) feature extractor, an Information Gain (IF) feature extractor, a Mutual Information (MI) feature extractor, a χ² Statistic (CHI) feature extractor, or a Term Strength (TS) feature extractor. Query-demographic classifier 206 can be any conventional database for classifying information. A query-demographic classifier can be, but is not limited to, a Support Vector Machines (SVM) classifier, a k-nearest neighbor (kNN) classifier, a Linear Least Squares Fit (LLSF) classifier, a Neural Network (NNet) classifier, or a Naive Bayes (NB) classifier. The search log 208 contains user search history information including search queries inputted by users and web pages browsed by users. User profile database 210 stores any type of user demographic attributes for all registered users.

The query-demographic predictor can be configured to obtain search results for corresponding search queries from the search engine 202 and extract features from the search results using the feature extractor 204. In an embodiment, a feature is a term or phrase that can be extracted from a broader contextual description and is used to identify a type of demographic attribute. For example, a feature can be extracted from a textual description of a search result wherein the feature would be associated with a type of demographic attribute related to the textual description. The query-demographic predictor can use the search log 208 to determine which users have been inputting certain search queries and obtain the users' corresponding demographic attributes from the user profile database 210. The query-demographic predictor can then associate and store those extracted features along with the corresponding user demographic attributes within the query-demographic classifier 206.

A page-demographic predictor is used to predict a confidence level for a particular demographic attribute given a certain web page. For example, the page-demographic predictor could predict the likelihood that a particular web page was browsed by a specific gender. In another example, the page-demographic predictor could predict the likelihood that a particular web page was browsed from someone at a specific location. The page-demographic predictor can predict any type of demographic attribute given a web page and should not be limited to just gender and location.

Page-demographic predictor 106 can include a feature extractor 212, a page-demographic classifier 214, a search log 216, and a user profile database 218. Feature extractor 204 can be any conventional feature extractor such as, but not limited to, a Document Frequency (DF) feature extractor, an Information Gain (IF) feature extractor, a Mutual Information (MI) feature extractor, a χ² Statistic (CHI) feature extractor, or a Term Strength (TS) feature extractor. Query-demographic classifier 206 can be any conventional database for classifying information. A query-demographic classifier can be, but is not limited to, a Support Vector Machines (SVM) classifier, a k-nearest neighbor (kNN) classifier, a Linear Least Squares Fit (LLSF) classifier, a Neural Network (NNet) classifier, or a Naive Bayes (NB) classifier. The search log 216 contains user search history information including search queries inputted by users and web pages browsed by users. User profile database 218 stores any type of user demographic attributes for all registered users.

The page-demographic predictor can be configured to identify and obtain web pages browsed by users from search log 216 and to extract features from the web pages using the feature extractor 212. The page-demographic predictor can also use the search log 216 to determine which users have been browsing certain web pages and can obtain the users' corresponding demographic attributes from the user profile database 210. The query-demographic predictor can then associate and store those extracted features along with the corresponding user demographic attributes within the page-demographic classifier 214.

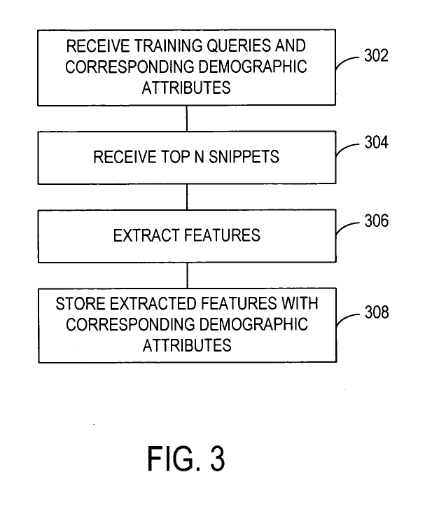

FIG. 3 illustrates an embodiment of a method for creating a query-demographic classifier. The query-demographic classifier is created by using information that is already known from the search log and user profile database in order to predict the demographic attributes of a non-registered user. At operation 302, the query-demographic predictor can transmit any desired training queries from the search log 208 to search engine 202. In an embodiment, the training queries are frequent search queries that are inputted by registered users. The training queries can be used to create a database of search queries with corresponding user demographic attributes that can be used to predict the demographic attributes of a non-registered user or a user with an incomplete user profile. For example, if a non-registered user inputs similar search queries as any of the training queries, then the query-demographic predictor can correlate the demographic attributes associated with the training query with the non-registered user.

After receiving the training queries, the search engine will then output the top search results for each training query. The query-demographic predictor can be configured to accept N search results, wherein N is the number of search results per search query. At operation 304, the query-demographic predictor can receive a snippet for each search result. In an embodiment, the snippets are textual descriptions of the search results. For example, conventional search engines provide a brief description for each search result as opposed to the entire web page in order to maximize the number of results that can be viewed on a single page. The brief description of the search result can be considered to be a snippet. The predictor uses the snippet to describe the corresponding search results of each search query as the queries themselves are sometimes too short to be understood by a feature extractor. The snippets, therefore, are used to extend the meaning of the search query.

At operation 306, features are extracted from the N snippets corresponding to each search result. The query-demographic predictor can retrieve from the search log the user IDs of the users who inputted the corresponding search queries and can then retrieve the user demographic attributes from the user profile database that are related to the user IDs. At operation 308, the extracted features and the corresponding user demographic attributes are stored together in the query-demographic classifier.

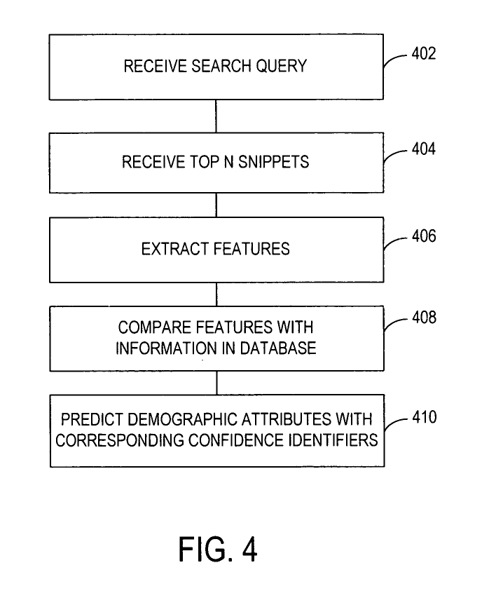

FIG. 4 illustrates an embodiment for predicting the demographic attributes of a user once the query-demographic classifier has been created. At operation 402, the query-demographic predictor receives a search query. At operation 404, N snippets are received from the N search results outputted from the search engine. At operation 406, features are extracted from the snippets. At operation 408, the extracted features are compared to the information stored in the query-demographic classifier. More specifically, the extracted features are compared to the stored features and the corresponding demographic attributes to determine if the extracted features resemble any of the stored features. An extracted feature will resemble a stored feature based on the configuration of the classifier. For example, a classifier can be configured to recognize that an extracted feature resembles a stored feature if 3 or more feature terms that correspond to a particular demographic attribute are identical to one another. In another example, resemblance can be determined if 2 or more of the feature terms that correspond to a particular demographic attribute are identical to one another. The classifier can include any other type of algorithm for determining whether the extracted feature and the stored feature resemble each other.

Based on the comparison, at operation 410, the query-demographic predictor can predict the demographic attributes of the user inputting the search query. For example, if the extracted features resembles any stored features in the classifier, the query-demographic predictor can take the demographic attributes that correspond to the stored features, and can, through use of various algorithms of the classifier, predict the demographic attributes of the search query by using the corresponding demographic attributes of the stored features.

The query-demographic predictor can additionally predict a confidence level for each demographic attribute that it predicts. A confidence level is a representation of how sure the query-demographic predictor is that the predicted demographic attribute is true. The confidence level can be represented by a confidence identifier. The confidence identifier is any identifier that can identify the level of confidence the predictor has that the demographic attribute is true. The confidence identifier can be any numerical or a textual description within an ascending/descending range of confidence. For example, the confidence identifier can be a percentage of confidence from 0%-100%. In another example, the confidence identifier can be textual descriptions such as “not confident,” “somewhat confident,” “confident,” and “very confident.” The query-demographic predictor can have any type of algorithm for determining the confidence level of a predicted demographic attribute. For example, in determining the gender of a user who inputs a particular search query, the query-demographic predictor can identify the number of male users within the classifier who inputted a search query that resembles the particular search query and divide by the total number of users who entered the same query. The result would be a percentage that would identify the confidence level that the user was a male. However, as mentioned previously, the query-demographic predictor can be configured to incorporate any other type of algorithm for determining a confidence level.

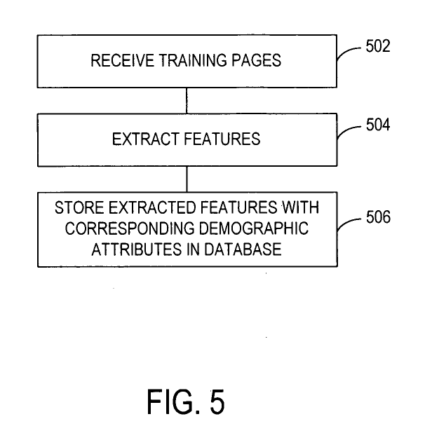

FIG. 5 illustrates an embodiment of a method for creating a page-demographic classifier. The page-demographic classifier is created by using information that is already known from the search log and user profile database in order to predict the demographic attributes of a non-registered user. At operation 502, the page-demographic predictor can retrieve training pages from the search log 216. In an embodiment, the training pages are frequent web pages browsed by users. At operation 504, features are extracted from the training pages. The page-demographic predictor can retrieve from the search log the user IDs of the users who browsed the corresponding training pages and can then retrieve the user demographic attributes from the user profile database that are related to the user IDs. At operation 506, the extracted features and the corresponding user demographic attributes are stored together in the page-demographic classifier.

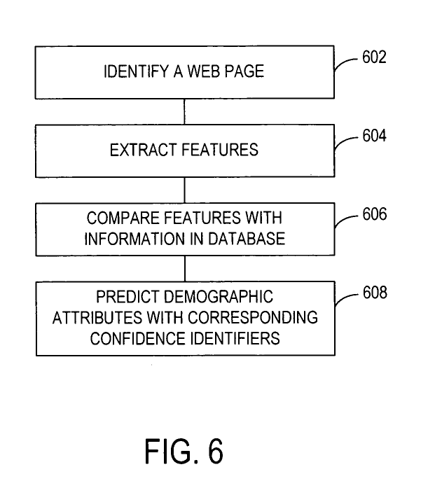

FIG. 6 illustrates an embodiment of a method for predicting the demographic attributes of a user browsing a particular web page once the page-demographic classifier has been created. At operation 602, a particular web page that has been browsed by a user is identified. At operation 604, features from the web page are extracted from the page's contents. At operation 606, the extracted features are compared to the information stored in the page-demographic classifier. More specifically, the extracted features are compared to the stored features and the corresponding demographic attributes to determine if the extracted features resemble any of the stored features. Based on the comparison, at operation 608, the page-demographic predictor can predict the demographic attributes of the user browsing the web page. For example, if the extracted features resembles any stored features in the classifier, the page-demographic predictor can take the demographic attributes that correspond to the stored features, and can, through use of various algorithms of the classifier, predict the demographic attributes of the web page by using the corresponding demographic attributes of the stored features.

The page-demographic predictor can also provide a corresponding confidence identifier, as explained above, for each demographic attribute that it predicts. For example, on a department store's web page, a plurality of features may be extracted such as “MP3 player” and “video games.” The page-demographic predictor may determine that 85% of men and 65% of people ages 31-45 are likely to be associated with the “MP3 player” feature. The page-demographic predictor may also determine that 55% of men and 95% of people ages 18-30 are associated with the feature “videogames.” The predictor can then take the averages of the respective features to determine that web page has a confidence level of 70% that men are more likely to browse the page. It can also be determined that the web page has a confidence level of 65% that people ages 18-30 are likely to browse the web page (assuming that 18-30 and 31-45 are the only two possible age categories). But again, any type of algorithm can be used to determine a confidence level for a particular demographic attribute and the invention should not be limited to the example given above.

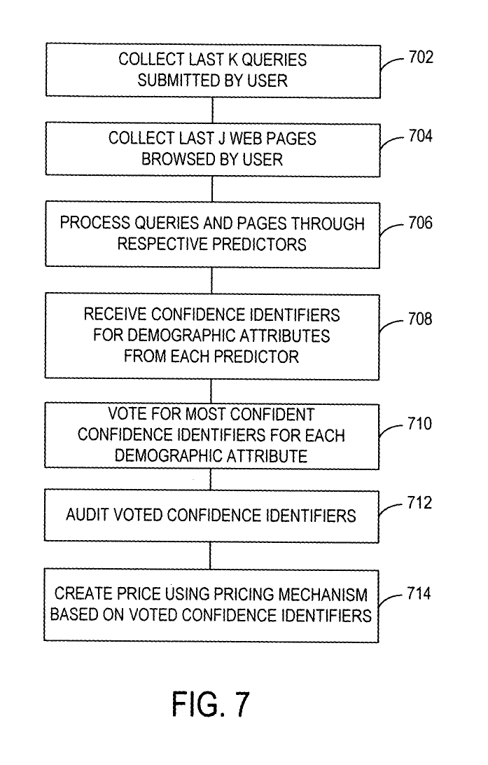

FIG. 7 illustrates an embodiment of a method for predicting demographic attributes using a user-demographic predictor. The user-demographic predictor is used to predict demographic attributes for specific users by evaluating each user's browsing and searching history. In an embodiment, a user demographic predictor combines the usage of a query-demographic predictor and a page-demographic predictor. At operation 702, a query-demographic predictor can collect the last K search queries submitted by a user from the search log, wherein K can be configured to be any predetermined number of search queries. At operation 704, a page-demographic predictor can collect the last J web pages browsed by the user from the search log, wherein J can be configured to be any predetermined number of web pages. At operation 706, the K search queries and J web pages can be processed through the respective predictors, and at operation 708 each predictor can output corresponding demographic attributes with confidence identifiers. At operation 710, the user-demographic predictor can vote for the most confident demographic attribute.

In an embodiment, the user-demographic predictor can vote for the demographic attribute that has a higher corresponding confidence identifier. For example, when evaluating gender, if the query-demographic predictor is 85% confident that the user is female and the page-demographic predictor is 50% confident that the user is male, then the user-demographic predictor will vote that the user is female since it has a higher confidence level. In another embodiment, the user-demographic predictor can vote for demographic attributes by taking the average of the confidence identifiers from the query and page-demographic predictors. For example, if the query-demographic predictor is 75% confident that the user is female and the page-demographic predictor is 15% confident that the user is female, then the average of the two is a 45% confidence level in which the user-demographic predictor will vote that the user is male since a male would have a higher confidence level of 55%. However, any voting mechanism/algorithm can be used, and the invention should not be limited to the two described above.

At operation 712, if the user is a registered user, the predicted and voted demographic attributes can be audited against the demographic information that has been stored in the user profile database. For example, the predicted and voted demographic attributes can be compared to the user's demographic attributes the user previously submitted in his/her profile to see if there are any similarities or differences. Such similarities and differences can be evaluated by an administrator, advertiser, or any other authorized user for any desired purpose.

In an embodiment, the predicted demographic attributes can be utilized by an advertiser to for determining which search queries, web pages, or users that he/she desires to bid on. In such an embodiment, at operation 714, a pricing mechanism can be used to create a bidding price for a corresponding search query, web page, or user based on the confidence identifier predicted for a given demographic attribute. For example, the query-demographic predictor can be used to inform advertisers which search queries fit their targeted demographic attribute values. The pricing mechanism can be configured to include any type of algorithm desired by a developer of the pricing mechanism. For example, if the query-demographic predictor is 75% confident that a particular search query is a female-oriented search query and the advertiser is interested in marketing to females, then the pricing mechanism could be configured to charge the advertiser 75% of the original advertisement price, wherein the original advertisement price can be any predetermined price.

The page-demographic predictor can also be used to inform advertisers which web pages fit their targeted demographic attribute values. The pricing mechanism can be configured to include any type of algorithm desired by a developer of the pricing mechanism. For example, if the page-demographic predictor is 85% confident that a particular web page is a male-oriented web page and the advertiser is interested in marketing to males, then the pricing mechanism could be configured to charge 85% of the original advertisement price, wherein the original advertisement price can be any predetermined price.

The user-demographic predictor can also be used to inform advertisers which users fit their targeted demographic attribute values. The pricing mechanism can be configured to include any type of algorithm desired by a developer of the pricing mechanism. For example, if the user-demographic predictor is 65% confident that a particular user is a male who lives in Virginia and the advertiser is interested in marketing to males who live in Virginia, then the pricing mechanism could be configured to charge 65% of the original advertisement price, wherein the original advertisement price can be any predetermined price.

While particular embodiments of the invention have been illustrated and described in detail herein, it should be understood that various changes and modifications might be made to the invention without departing from the scope and intent of the invention. The embodiments described herein are intended in all respects to be illustrative rather than restrictive. Alternate embodiments will become apparent to those skilled in the art to which the present invention pertains without departing from its scope.

From the foregoing it will be seen that this invention is one well adapted to attain all the ends and objects set forth above, together with other advantages, which are obvious and inherent to the system and method. It will be understood that certain features and sub-combinations are of utility and may be employed without reference to other features and sub-combinations. This is contemplated and within the scope of the appended claims.

We claim:

1. A method for predicting user demographic attributes, comprising:
receiving a search query;
extracting at least one feature associated with the search query;
correlating each extracted feature with one or more attributes; and
determining a demographic profile based on the correlated attributes.

2. The method according to claim 1, wherein the at least one feature is extracted from a snippet associated with the search query.

3. The method according to claim 1, further comprising providing a confidence level that is represented by a confidence identifier.

4. The method according to claim 3, further comprising charging an advertiser a price for the at least one search query based on the confidence identifier.

5. The method according to claim 4, wherein the confidence identifier is a percentage and the price is an original price multiplied by the percentage.

6. The method according to claim 2, wherein the snippet is associated with a document.

7. The method according to claim 6, further comprising extracting at least one feature associated with the document.

8. The method according to claim 7, further comprising correlating each extracted feature with one or more attributes.

9. The method according to claim 8, further comprising determining a demographic profile based on the correlated attributes.

10. A method for predicting user demographic attributes, comprising:
identifying a document;
extracting at least one feature associated with the identified document;
correlating the at least one feature with one or more attributes; and
determining a first demographic profile based on the one or more attributes.

11. The method according to claim 10, wherein a confidence level is provided that is represented by a confidence identifier.

12. The method according to claim 11, further comprising charging an advertiser a price for the at least one web page based on the confidence identifier.

13. The method according to claim 12, wherein the confidence identifier is a percentage and the price is an original price multiplied by the percentage.

14. The method according to claim 10, wherein the identified document is associated with a search query.

15. The method according to claim 14, further comprising extracting one or more features associated with the search query.

16. The method according to claim 15, wherein the one or more features are extracted from a snippet associated with the query.

17. The method according to claim 15, further comprising correlating the one or more features with at least one attribute.

18. The method according to claim 16, further comprising determining a second demographic profile based on the at least one attribute.

19. A method for predicting user demographic attributes, comprising:
receiving at least one search query;
identifying at least one web page;
determining a first demographic profile associated with the at least one search query;
determining a second demographic profile associated with the at least one web page; and
determining a third demographic profile based on the first and second demographic profiles.

20. The method according to claim 19, wherein determining the third demographic profile further comprises voting for demographic attributes within the first and second demographic profiles that have a higher corresponding confidence identifier.
